(19) United States
(12) Patent Application Publication
(10) Pub. No.: US 2016/0161796 A1
(43) Pub. Date: Jun. 9, 2016

(54) LIQUID CRYSTAL DISPLAY AND METHOD OF MANUFACTURING THE SAME

(71) Applicant: SAMSUNG DISPLAY CO., LTD., Yongin-City (KR)

(72) Inventors: JEONGHO LEE, Yongin-City (KR); HYANGYUL KIM, Yongin-City (KR); JUNGHO PARK, Yongin-City (KR); JUNHO SONG, Yongin-City (KR); JEANHO SONG, Yongin-City (KR); SOOJUNG CHAE, Yongin-City (KR)

(21) Appl. No.: 14/703,162

(22) Filed: May 4, 2015

(30) Foreign Application Priority Data
Dec. 4, 2014 (KR) 10-2014-0173245

(51) Int. Cl. G02F 1/1335; G02F 1/1368; G02F 1/1337

(52) U.S. Cl. CPC G02F 1/133514; G02F 1/133788; G02F 1/1368; G02F 1/133516

(57) ABSTRACT

A liquid crystal display includes a display substrate, a plurality of unit pixels, a switching device provided per unit pixel on the display substrate and configured to drive a corresponding unit pixel of the plurality of unit pixels, and an alignment layer on an inner surface of the display substrate. The alignment layer defines a pixel area formed as a single domain per unit pixel, and a liquid crystal is aligned such that liquid crystal alignment directions of unit pixels adjacent in at least one direction are opposite to each other.

### CROSS-REFERENCE TO RELATED APPLICATION(S)

This application claims priority under 35 U.S.C. §119 to Korean Patent Application No. 10-2014-0173245, filed on Dec. 4, 2014, the disclosure of which is herein incorporated by reference in its entirety.

### TECHNICAL FIELD

Exemplary embodiments of the inventive concept relate to a liquid crystal display and a method of manufacturing the same, and more particularly, to a liquid crystal display having a high transmittance and a method of manufacturing the same.

### DISCUSSION OF THE RELATED ART

Generally, a liquid crystal display includes a display substrate (a lower substrate), an opposite substrate (an upper substrate) facing the display substrate and a liquid crystal layer therebetween.

A plurality of data lines and a plurality of gate lines defining a plurality of pixel areas are arranged on the display substrate. Switching devices such as thin film transistors (TFTs) are arranged in areas where the data lines and the gate lines cross each other. Pixel electrodes are located in the pixel areas.

A twisted nematic (TN) mode or a plane to line switching (PLS) mode is used to drive a liquid crystal molecule in a direction perpendicular to a substrate (lower or upper substrate). To secure a wide angle of view, the PLS mode may be used.

In a liquid crystal display using the PLS mode, a pixel electrode and a common electrode for generating an electric field are arranged to be insulated from each other on a display substrate including TFTs. In order to display an image, a light transmittance of a liquid crystal layer is controlled via liquid crystal particles horizontally arranged according to a fringe field formed between the pixel electrode and the common electrode. However, in a liquid crystal display using the PLS mode, a non-uniform vertical field may occur in a central portion of the pixel electrode and in a central portion of the common electrode. The non-uniform vertical field may deteriorate the transmittance of the liquid crystal display.

For example, in order to realize the liquid crystal display using the PLS mode, a large number of mask processes are required in order to arrange the pixel electrode and the common electrode on the display substrate.

However, to manufacture a liquid crystal display using the TN mode, fewer mask processes than those needed to realize the liquid crystal display using the PLS mode may be required. Thus, the manufacturing costs may be reduced.

### SUMMARY

Exemplary embodiments of the inventive concept include a liquid crystal display having a high aperture ratio and a low manufacturing cost, and a method of manufacturing the same.

The inventive concept will be more apparent from the description of exemplary embodiments of the inventive concept.

In an exemplary embodiment of the inventive concept, a liquid crystal display includes a display substrate, a switching device provided per unit pixel on the display substrate and configured to drive a pixel, and an alignment layer on an inner surface of the display substrate, wherein the alignment layer defines a pixel area formed as a single domain per unit pixel, and a liquid crystal is aligned such that liquid crystal alignment directions of unit pixels adjacent in at least one direction are the opposite each other.

According to an exemplary embodiment of the inventive concept the liquid crystal display may include a plurality of color display units, each of the color display units including a plurality of unit pixels configured to display a plurality of colors, wherein unit pixels of adjacent color display units which display the same color may have opposite liquid crystal alignment directions.

Each of the color display units may include three unit pixels arranged in a first direction in order to display red, green, and blue colors, and the three unit pixels may include a unit pixel for displaying the red color, a unit pixel for displaying the green color, and a unit pixel for displaying the blue color. Unit pixels for displaying the red color of two adjacent color display units may have opposite liquid crystal alignment directions. Unit pixels for displaying the green color of two adjacent color display units may have opposite liquid crystal alignment directions. Unit pixels for displaying the blue color of two adjacent color display units may have opposite liquid crystal alignment directions.

Unit pixels arranged in a second direction that crosses the first direction may display the same color.

Adjacent unit pixels displaying the same color in the second direction may have opposite liquid crystal alignment directions.

The unit pixels may be arranged in a two-dimensional array, wherein a liquid crystal direction of a first unit pixel is opposite to a liquid crystal alignment direction of a second unit pixel adjacent to the first unit pixel in at least the first direction or a second direction, wherein the second direction crosses the first direction.

The liquid crystal display may include a color filter on the display substrate.

The alignment layer may include a light-alignment layer.

The liquid crystal display may be provided to operate in a twisted nematic (TN) mode.

In an exemplary embodiment of the inventive concept, a method of manufacturing a liquid crystal display includes preparing a display substrate including a switching device per unit pixel to drive a pixel, forming a light-reactive material layer on the display substrate, irradiating the light-reactive material layer with light at a predetermined incident angle through a shadow mask including a blocking area and a transmittance area that have a size corresponding to a size of the unit pixel, wherein the blocking area and the transmittance area are alternately located in at least one of a first direction and a second direction crossing the first direction, shifting the shadow mask by a distance corresponding to a width of the unit pixel, and irradiating the light-reactive material layer with light through the shadow mask at an opposite incident angle on the light-reactive material layer, to form a light alignment layer such that a pixel area per unit pixel forms a single domain and liquid crystal alignment directions of adjacent unit pixels are opposite each other.

The light may include linearly polarized ultraviolet rays.

When the predetermined incident angle is α, the opposite incident angle may be −α.

In an exemplary embodiment of the inventive concept, a liquid crystal display includes a display substrate, a plurality of unit pixels, a switching device provided per unit pixel on the display substrate and configured to drive a corresponding unit pixel of the plurality of unit pixels, and an alignment layer on an inner surface of the display substrate, wherein the alignment layer defines a pixel area formed as a single domain per unit pixel, and wherein a liquid crystal is aligned such that liquid crystal alignment directions of unit pixels adjacent in at least a first direction are opposite to each other.

In an exemplary embodiment of the inventive concept, a method of manufacturing a liquid crystal display includes forming a light-reactive material layer on a display substrate including a plurality of unit pixels and a switching device per unit pixel, irradiating the light-reactive material layer with light at a predetermined first incident angle through a shadow mask including a blocking area and a transmittance area, wherein the blocking area and the transmittance area each have a size corresponding to a size of each unit pixel, and wherein the blocking area and the transmittance area are alternately located in at least one of a first direction and a second direction crossing the first direction, shifting the shadow mask by a distance corresponding to a width of the unit pixel, and irradiating the light-reactive material layer with light through the shadow mask at a second incident angle, opposite to the first incident angle, on the light-reactive material layer to form a light alignment layer such that a pixel area per unit pixel forms a single domain and liquid crystal alignment directions of adjacent unit pixels are opposite to each other.

In an exemplary embodiment of the inventive concept, a liquid crystal display includes a display substrate, a plurality of unit pixels, a switching device provided per unit pixel on the display substrate and configured to drive a corresponding unit pixel of the plurality of unit pixels, and an alignment layer on an inner surface of the display substrate, wherein the alignment layer defines a pixel area formed as a single domain per unit pixel, wherein the plurality of unit pixels includes a first unit pixel adjacent to a second unit pixel in a first direction, and a third unit pixel adjacent to the second unit pixel in a second direction crossing the first direction, and wherein at least the first unit pixel or the third unit pixel has a liquid crystal alignment direction opposite to a liquid crystal alignment direction of the second unit pixel.

### BRIEF DESCRIPTION OF THE DRAWINGS

The inventive concept will become apparent and more readily appreciated from the description of exemplary embodiments of the inventive concept in conjunction with the accompanying drawings in which:

FIG. 1 is a schematic view of a liquid crystal display according to an exemplary embodiment of the inventive concept;

FIG. 2 is a view illustrating an example of a liquid crystal alignment state of the liquid crystal display of FIG. 1;

FIG. 3 is a view of an example of a liquid crystal alignment direction of a color display unit of the liquid crystal display of FIG. 1;

FIG. 4 is a view illustrating a method of manufacturing a liquid crystal display according to an exemplary embodiment of the inventive concept;

FIG. 5 is a schematic plan view of an example of a display substrate which may be used in the liquid crystal display of FIG. 1;

FIGS. 6A through 6G are views illustrating a method of manufacturing the display substrate of FIG. 5;

FIG. 7 is a schematic plan view of an example of the display substrate which may be adopted in the liquid crystal display of FIG. 1 in accordance with an exemplary embodiment of the inventive concept;

FIGS. 8A through 8F are views illustrating a method of manufacturing the display substrate of FIG. 7; and

FIG. 9 is a view illustrating a liquid crystal alignment state of a liquid crystal display according to an exemplary embodiment of the inventive concept.

### DETAILED DESCRIPTION OF THE EXEMPLARY EMBODIMENTS

Reference will now be made in detail to exemplary embodiments of the inventive concept which are illustrated in the accompanying drawings, wherein like reference numerals refer to like elements throughout. In this regard, the exemplary embodiments of the inventive concept may have different forms and should not be construed as limiting the inventive concept to the exemplary embodiments described herein. Accordingly, exemplary embodiments of the inventive concept are merely described below, by referring to the figures to explain aspects of the inventive concept. Expressions such as “at least one of,” when preceding a list of elements, may modify the entire list of elements but may not modify an individual element of the list.

It will be understood that the terms “first,” “second,” etc. may be used herein to describe various components. The various components should not be limited by these terms. The various components may be used to distinguish one component from another.

It will be understood that when a layer, region or component is referred to as being “formed on” a second layer, region or component, the layer, region or component can be directly or indirectly formed on the second layer, region, or component. For example, intervening layers, regions, or components may or may not be present.

Sizes of elements in the drawings may be exaggerated for convenience of explanation. Since sizes and thicknesses of components in the drawings may be arbitrarily illustrated for convenience of explanation, and exemplary embodiment of the inventive concept are not limited thereto.

When a certain embodiment may be implemented differently, a specific process order may be performed differently from the described order. For example, two consecutively described processes may be performed substantially at the same time or performed in an order opposite to the described order.

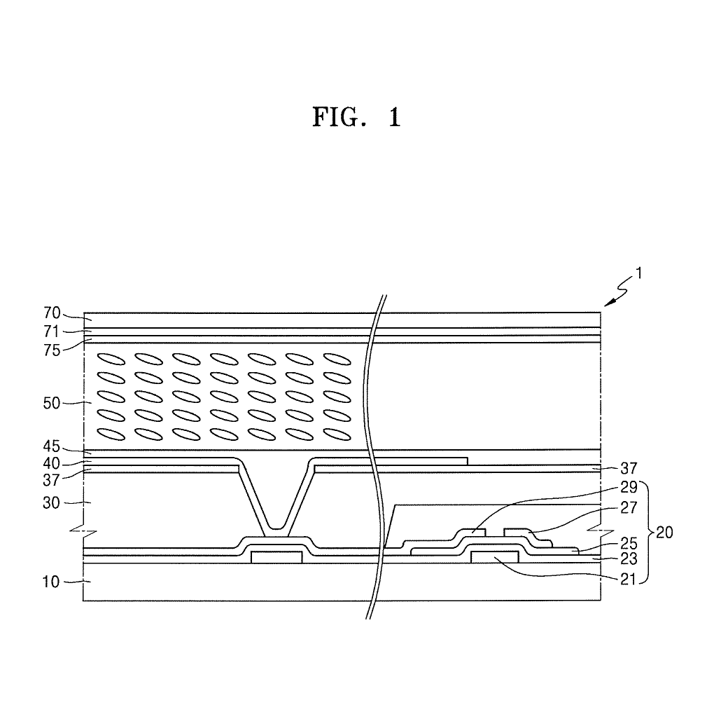

FIG. 1 schematically illustrates a liquid crystal display 1 according to an exemplary embodiment of the inventive concept. In FIG. 1, a unit pixel is illustrated as an example.

Referring to FIG. 1, the liquid crystal display 1 includes a display substrate 10, an opposite substrate 70, and a liquid crystal layer 50 interposed therebetween.

A switching device 20 configured to drive a pixel may be provided per unit pixel on the display substrate 10, and a pixel electrode 40 electrically connected to the switching device 20 is provided on the display substrate 10. The display substrate 10 may further include an alignment layer 45 on the pixel electrode 40. A color filter 30 may be formed on the display substrate 10. A common electrode 71 may be provided on the opposite substrate 70 and an alignment layer 75 formed on the common electrode may be provided on the opposite substrate 70.

The switching device 20 and the pixel electrode 40 may be formed per unit pixel on the display substrate 10 and the switching device 20 and the pixel electrode 40 forming the unit pixel may be provided in a two-dimensional array. For example, a plurality of gate lines and a plurality of data lines may be formed on the display substrate 10.

The display substrate 10 may be, for example, a glass substrate, or a plastic substrate including a material such as polyethylen terephthalate (PET), polyethylen naphthalate (PEN) or polyimide.

The switching device 20 may include a gate electrode 21, a gate insulating layer 23, an active layer 25, a source electrode 27 and a drain electrode 29 as a thin film transistor (TFT). The gate electrode 21 may be formed on the display substrate 10 and the gate insulating layer 23 may be formed on the gate electrode 21. The active layer 25 may be formed on a portion of the gate insulating layer 23 that corresponds to the gate electrode 21. The source electrode 27 and the drain electrode 29 may be formed on the active layer 25 to be apart from each other.

A light-shielding member 35 may be provided to cover the switching device 20 and prevent the switching device 20 from being damaged by external light. A black matrix may be formed on the display substrate 10 and a light-shielding member 35 may be formed simultaneously with the black matrix.

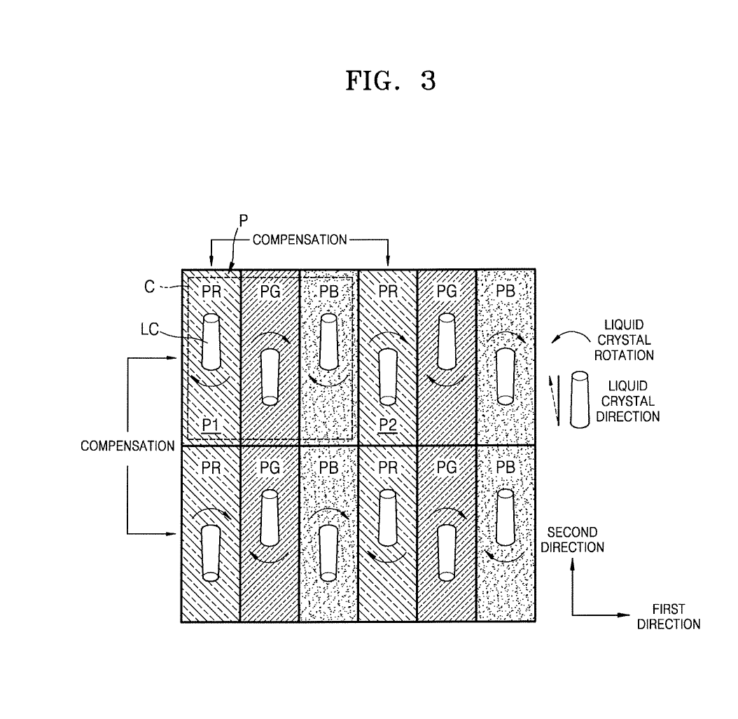

The color filter 30 may be formed on the display substrate 10 on which the switching device 20 and the light-shielding member 35 are formed. The color filter 30 may be formed such that the color filter 30 covers the switching device 20 and the light-shielding member 35 and contacts the display substrate except for an area in which the light-shielding member 35 may be formed. The color filter 30 formed in a unit pixel corresponds to any one of, for example, a red color filter R, a green color filter G and a blue color filter B. The red color filter R, the green color filter G and the blue color filter B may be consecutively formed in unit pixels. As illustrated in FIG. 3, which will be described later, the red color filter R, the green color filter G and the blue color filter B may be repeatedly arranged in a first direction, for example, a horizontal direction. The sequence of the red color filter R, the green color filter G and the blue color filter B, as arranged in the first direction, may be arranged in a second direction, for example, a vertical direction. An arrangement of the red color filter R, the green color filter G and the blue color filter B in the first direction may vary.

A passivation layer 37 may be formed on the switching device 20 to cover and protect the switching device 20. Although FIG. 1 illustrates that the passivation layer 37 is formed on the color filter 30, the passivation layer 37 may be formed between the switching device 20 and the color filter 30.

The alignment layer 45 and the alignment layer 75 may be provided on the display substrate 10 and the opposite substrate 70, respectively. The alignment layer 45 and the alignment layer 75 may be horizontal alignment layers. The alignment layers 45 and 75 may include, for example, light-alignment layers. The liquid crystal layer 50 may be aligned by the alignment layers 45 and 75 to operate in, for example, a twisted nematic (TN) mode. The alignment layers 45 and 75 may be provided such that liquid crystals have a pre-tilt angle. Polarizers may be provided on an outer surface of the display substrate 10 and the opposite substrate 70. For example, transmittance axes of the two polarizers may be arranged to cross at right angles or to be parallel with each other. When the two polarizers are arranged such that the transmittance axes cross at right angles and the liquid crystal layer 50 is aligned to operate in the TN mode, the liquid crystal display 1 may operate in a normally white mode. In contrast, when the two polarizers are arranged such that the transmittance axes are in parallel with each other and the liquid crystal layer 50 is aligned to operate in the TN mode, the liquid crystal display 1 may operate in a normally black mode. For example, the liquid crystal display 1 according to an exemplary embodiment of the inventive concept may be of a reflective type. In this case, the polarizer may be arranged only on a light exit surface. That is, the polarizer may be arranged only on the outer surface of the opposite substrate 70.

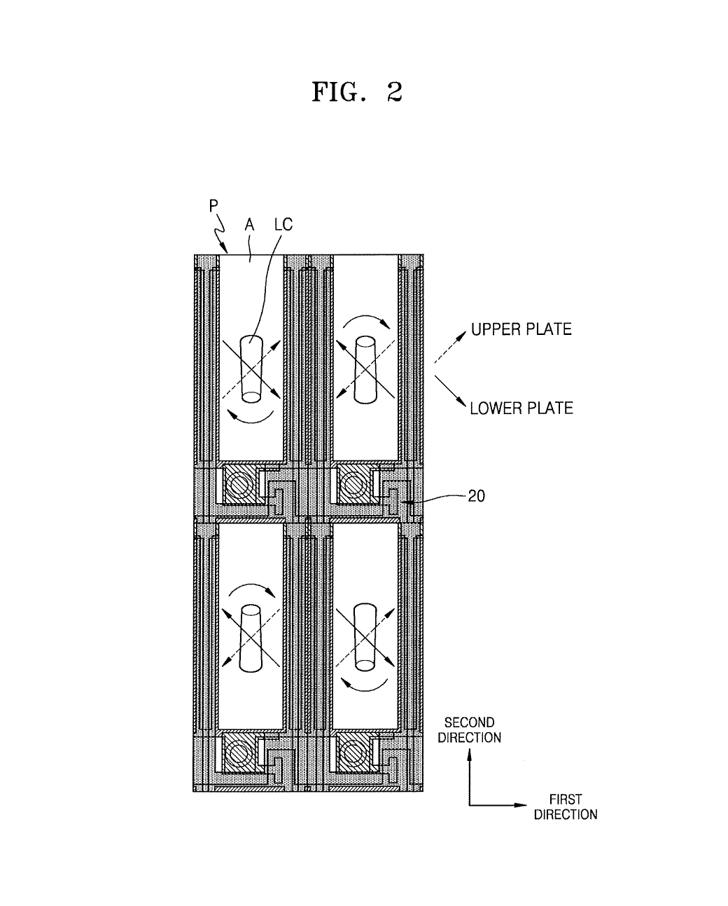

FIG. 2 illustrates an example of a liquid crystal alignment state of the liquid crystal display 1 according to an exemplary embodiment of the inventive concept. FIG. 3 illustrates a liquid crystal alignment direction of a color display unit C in the liquid crystal display 1 according to an exemplary embodiment of the inventive concept.

Referring to FIGS. 2 and 3, the switching device 20 configured to drive a pixel is provided per unit pixel P on the display substrate 10. A pixel area A of each unit pixel P may be formed as a single domain. A liquid crystal LC may be aligned such that a liquid crystal alignment direction of a first unit pixel P is opposite to a liquid crystal alignment direction of a second unit pixel P which is adjacent (e.g., directly adjacent) to the first unit pixel P in at least one direction (e.g., left or right along the first direction or up or down along the second direction). For example, the unit pixels P may be arranged in a two-dimensional may. In an exemplary embodiment, the two-dimensional array includes a first unit pixel adjacent to a second unit pixel in the first direction wherein the first unit pixel is arranged left or right of the second unit pixel, and a third unit pixel adjacent to the second unit pixel in a second direction which is perpendicular to the first direction wherein the third unit pixel is arranged above or below the second unit pixel. At least the first unit pixel or the third unit pixel has a liquid crystal alignment direction opposite to a liquid crystal alignment direction of the second unit pixel. FIGS. 2 and 3 illustrate examples in which a liquid crystal alignment direction of a first unit pixel P is opposite to a liquid crystal alignment direction of a second unit pixel P adjacent to the first unit pixel P in at least one direction (e.g., left or right in a direction along a first axis, or up or down in a direction along a second axis). Herein, the first axis may refer to a horizontal axis and the second axis may refer to a vertical axis. In FIG. 2, the arrow indicated in a dotted line (the upper plate) indicates the liquid crystal alignment direction on the opposite substrate 70 and the arrow indicated in a full line (the lower plate) indicates the liquid crystal alignment direction on the display substrate 10. As shown in FIGS. 2 and 3, in an exemplary embodiment, when a first unit pixel adjacent to a second unit pixel in the first direction wherein the first unit pixel is arranged left or right of the second unit pixel, and a third unit pixel adjacent to the second unit pixel in a second direction which is perpendicular to the first direction wherein the third unit pixel is arranged above or below the second unit pixel, both the first and third unit pixels have liquid crystal alignment and/or rotation directions opposite to the liquid crystal alignment and/or rotation directions of the second unit pixel, respectively.

The color display unit C may include a plurality of unit pixels P to display a plurality of colors as illustrated in FIG. 3. Unit pixels indicating the same color in adjacent color display units C may have opposite liquid crystal alignment directions.

For example, each color display unit C includes three unit pixels P arranged in a first direction extending along a first axis. The first axis may extend, for example, in a horizontal direction. Each color display unit may display red (R), green (G), and blue (B) colors. The three unit pixels P may include a unit pixel PR for displaying the R color, a unit pixel PG for displaying the G color and a unit pixel PB for displaying the B color. For example, the unit pixels PR for displaying the R color of two adjacent color display units C may have opposite liquid crystal alignment directions, the unit pixels PG for displaying the G color of the two adjacent color display units C may have opposite liquid crystal alignment directions, and the unit pixels PB for displaying the B color of the two adjacent color display units C may have opposite liquid crystal alignment directions, as illustrated in FIG. 3. For example, since the unit pixels P in the adjacent color display units C which indicate the same color may have the opposite liquid crystal alignment directions, optical compensation may be performed in the same color. For example, unit pixels P adjacent in the first direction that indicate different colors may also have opposite liquid crystal alignment directions. Accordingly, the optical compensation may be performed not only in the same color but also in the unit pixels P adjacent in the first direction.

Also, as described above, when each color display unit C includes three unit pixels P arranged in the first direction, unit pixels P arranged in a second direction which crosses the first direction, for example, a vertical direction, may indicate the same color. For example, the unit pixels P indicating the same color in the second direction may also have adjacent unit pixels P having opposite liquid crystal alignment directions. Accordingly, optical compensation may be performed in the unit pixels adjacent in the second direction.

Since a liquid crystal direction of a first unit pixel P is opposite to a liquid crystal alignment direction of a second unit pixel P adjacent to the first unit pixel P in at least one direction (e.g., left or right in a direction along the first axis, or up or down in a direction along the second axis), as illustrated in FIG. 3, the optical compensation may be performed so that a horizontal line color stain which may be generated in the PLS mode does not occur. The optical compensation may be performed in adjacent unit pixels.

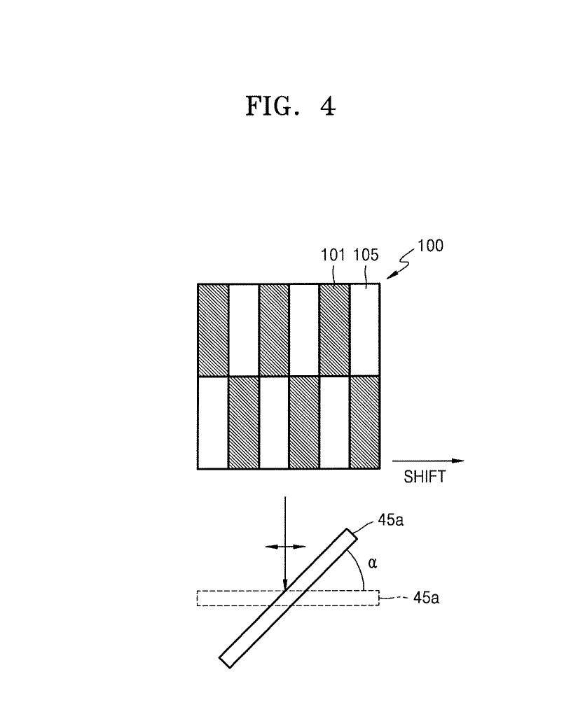

A method of manufacturing the liquid crystal display 1 in accordance with an exemplary embodiment of the inventive concept will be described by referring to FIG. 4.

As shown in FIG. 4, a light-reactive material layer 45a may be formed on the display substrate 10 in which the switching device 20 configured to drive a pixel is provided per unit pixel P. In FIG. 4, only the light-reactive material layer 45a is illustrated and the display substrate 10 is not illustrated for clarity. The light-reactive material layer 45a may be provided such that a light-alignment layer, not shown for clarity, may be formed in the light-reactive material layer 45a by having the light-reactive material layer 45a irradiated by linearly polarized ultraviolet rays.

The alignment layer 45 may include the light-alignment layer. The light-alignment layer may be formed by having the light-reactive material layer 45a irradiated with light for light alignment. For example, the alignment layer 45 may be formed such that a liquid crystal direction of a first unit pixel P is opposite to a liquid crystal alignment direction of a second unit pixel P adjacent to the first unit pixel P in at least one direction (e.g., left or right in a direction along the first axis, or up or down in a direction along the second axis).

To form the light-alignment layer, the light-reactive material layer 45a may be irradiated with light for light alignment through a shadow mask 100 as illustrated in FIG. 4. Referring to FIG. 4, the shadow mask 100 may have a structure in which a blocking area 101 that has a size corresponding to a size of a unit pixel P and a transmittance area 105 that has a size corresponding to a size of a unit pixel P are alternately located in a first direction and alternatively located in at least one of a first direction and a second direction, as shown in FIG. 4. FIG. 4 exemplarily illustrates that the shadow mask 100 has a structure in which the blocking area 101 may have a size corresponding to a size of the a pixel P, the transmittance area 105 may have a size corresponding to a size of a unit pixel P, and that the blocking area 101 and the transmittance area 105 may be alternately located in the first and second direction axes. The light alignment layer may be formed in order to align the liquid crystal LC in the liquid crystal alignment direction illustrated in FIGS. 2 and 3.

For example, the light-reactive material layer 45a may be irradiated with linearly polarized ultraviolet rays at a predetermined incident angle α through the shadow mask 100. The shadow mask 100 may be shifted by a distance corresponding to a width of a unit pixel P in a direction as shown by the arrow with the label “SHIFT” in FIG. 4. After shifting the shadow mask 100 accordingly, the light-reactive material layer 45a is again irradiated with light for light alignment at an opposite incident angle −α through the shadow mask 100.

By this process, the light alignment layer may be formed such that the pixel area A per unit pixel P forms a single domain such that a liquid crystal direction of a first unit pixel P is opposite to a liquid crystal alignment direction of a second unit pixel P adjacent to the first unit pixel P in at least one direction (e.g., left or right in a direction along the first axis, or up or down in a direction along the second axis).

When the alignment layer 45 formed as the light-alignment layer is formed, unit pixels P are arranged in a two-dimensional array, and the liquid crystal LC may be aligned such that a liquid crystal direction of a first unit pixel P is opposite to a liquid crystal alignment direction of a second unit pixel P adjacent to the first unit pixel P in at least one direction (e.g., left or right in a direction along the first axis, or up or down in a direction along the second axis).

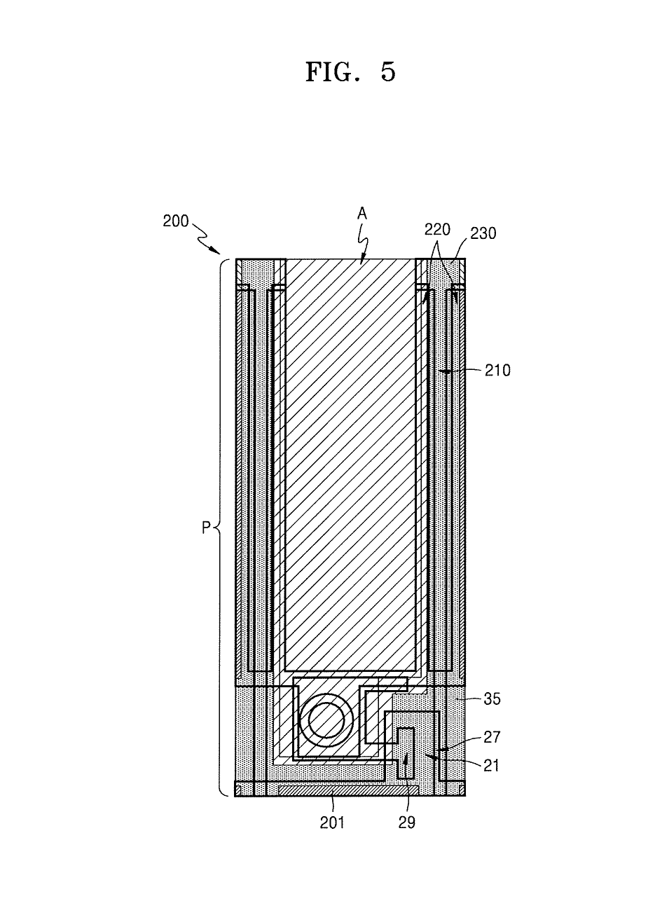

FIG. 5 is a plan view of a display substrate 200 which may be adopted as the display substrate 10 of the liquid crystal display 1 of FIG. 1. FIG. 5 illustrates a unit pixel P of the display substrate 200. In the display substrate 200, the unit pixels P illustrated in FIG. 5 are arranged in a two-dimensional array.

Referring to FIG. 5, a gate line 201 and a data line 210 may be formed on the display substrate 200. The gate line 201 may be electrically connected to a gate electrode 21, and the data line 210 may be electrically connected to the source electrode 27 of the switching device 20.

The gate line 201 and the gate electrode 21 may be simultaneously formed. For example, when the gate line 201 is formed, a gate wiring pattern 220 may further be provided in parallel with the data line 210. The gate wiring pattern 220 may have a portion formed by two divided lines and the data line 210 may be located between the two lines.

When the gate wiring pattern 220 is formed as the divided structure as described above, a wiring capacitance may be decreased so that power consumption of the liquid crystal display 1 may be reduced.

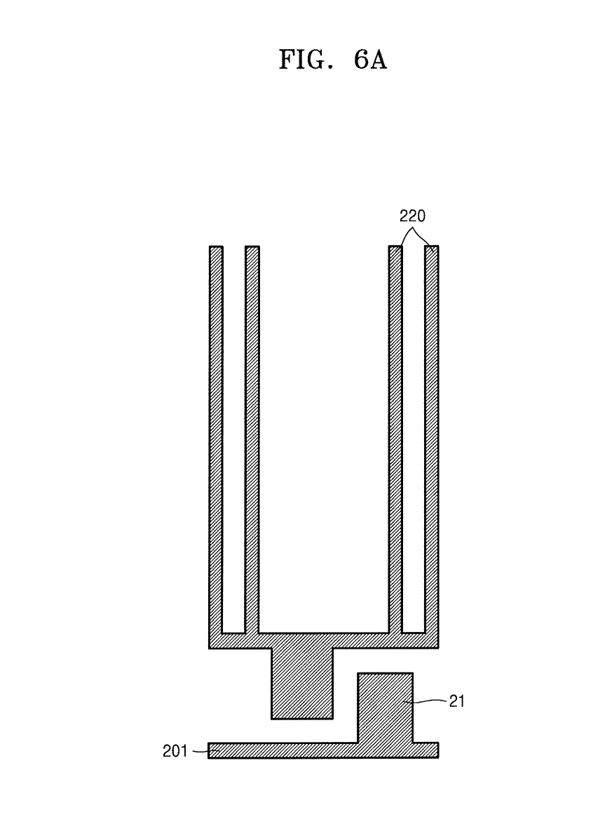

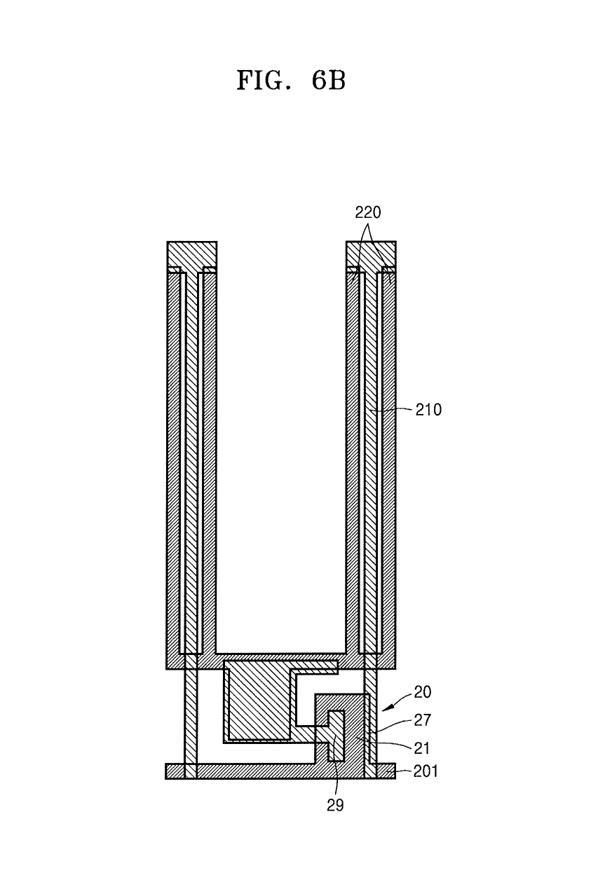

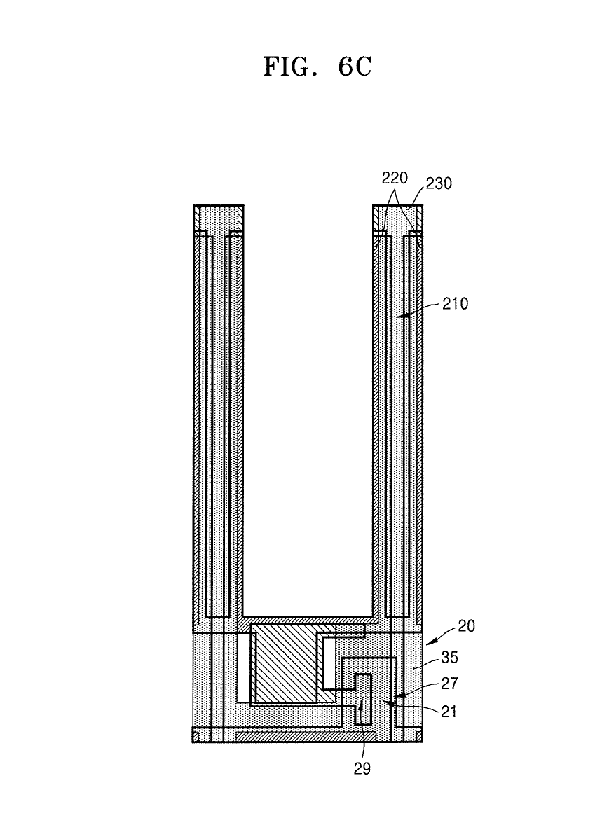

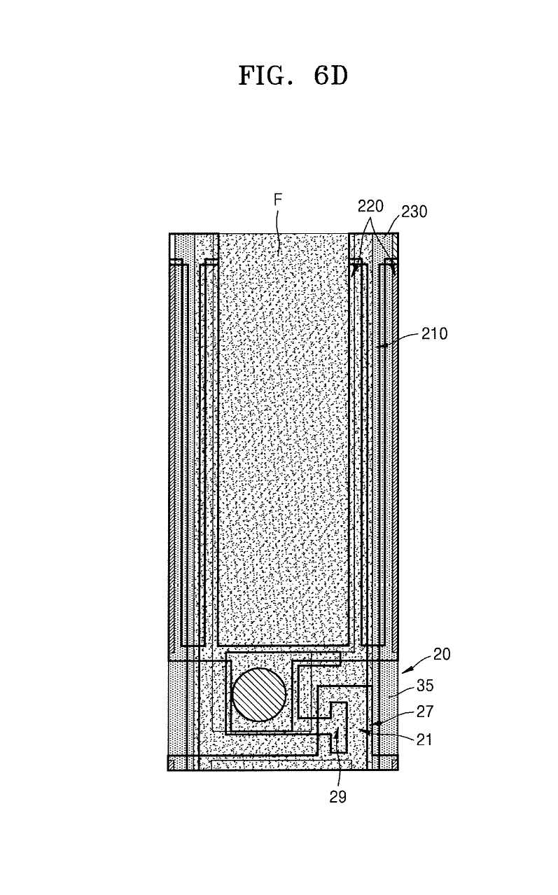

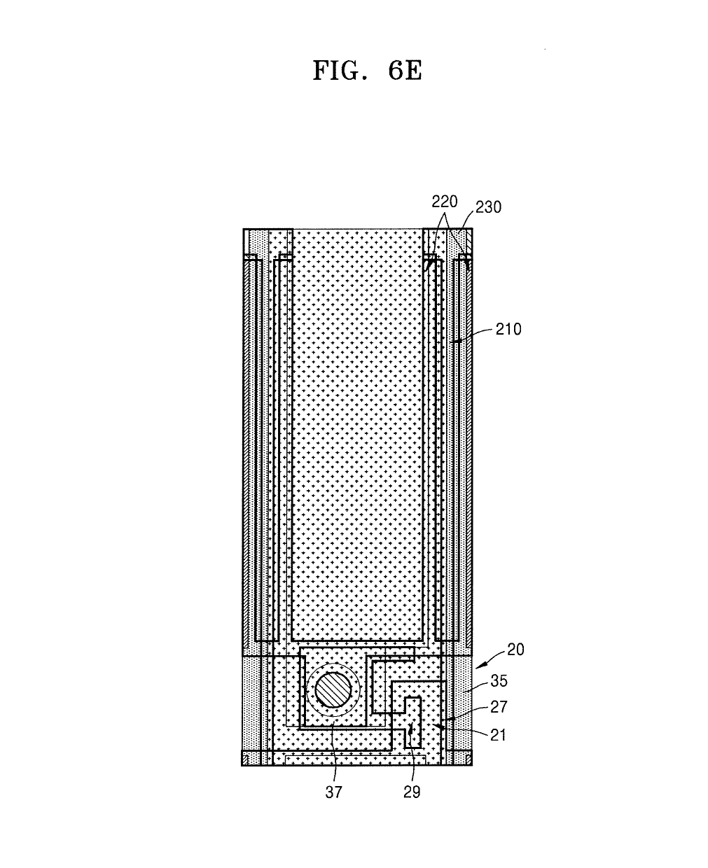

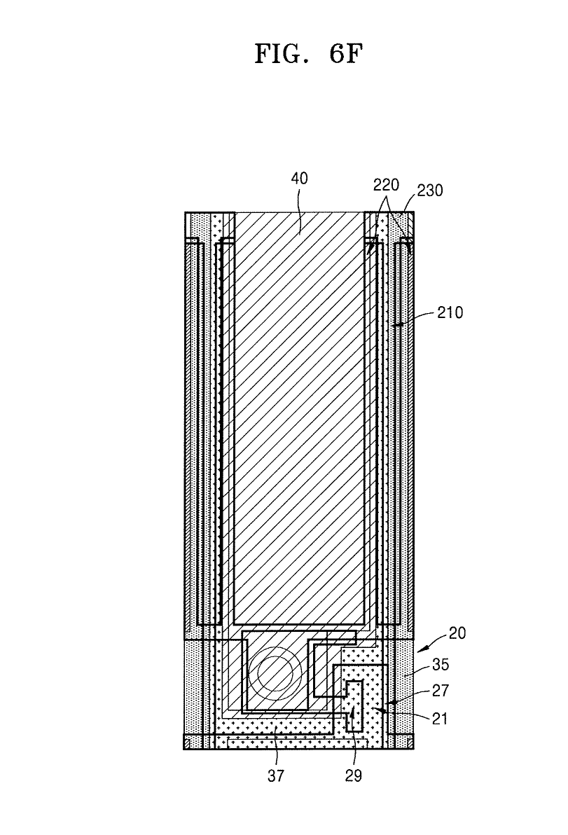

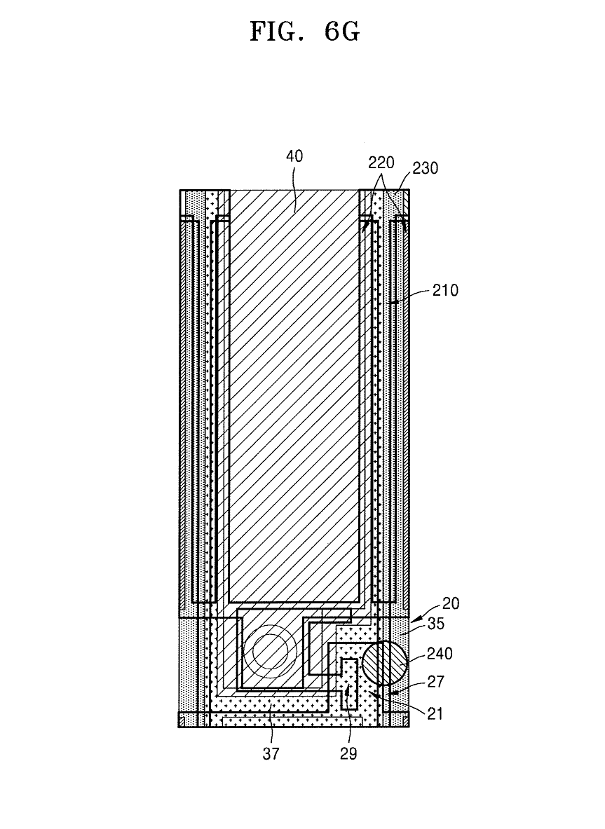

FIGS. 6A through 6G illustrate a method of manufacturing the display substrate 200 of FIG. 5 according to an exemplary embodiment of the inventive concept.

Referring to FIG. 6A, when the gate electrode 21 is formed, the gate line 201 and the gate wiring pattern 220 are formed.

As illustrated in FIG. 6B, the gate insulating layer 23, not illustrated for clarity of illustration, and the active layer 25, not illustrated for clarity of illustration, may be formed to cover the gate electrode 21. The source electrode 27 and the drain electrode 29 may be formed to be apart from each other. The data line 210 may be formed to be electrically connected to the source electrode 27 when the source electrode 27 and the drain electrode 29 are formed.

After the switching device 20 is formed as described above, a black matrix 230 may be formed on the display substrate 200, as illustrated in FIG. 6C. The black matrix 230 may be formed along the data line 210, for example, to prevent light leakage between the data line 210 and the gate wiring pattern 220. When the black matrix 230 is formed, the light-shielding member 35 which covers and protects the switching device 20 may be simultaneously formed. Here, the black matrix 230 and the light-shielding member 35 are separately indicated. However, the light-shielding member 35 may also be included in the black matrix 230.

Referring to FIG. 6D, an array of a red, green, and blue color filter F may be formed in unit pixel P. FIG. 6D illustrates an example in which the color filter F of the unit pixel P is formed to cover not only the pixel area A but also at least a portion of the black matrix 230 and at least a portion of the light-shielding member 35.

Next, as illustrated in FIGS. 6E and 6F, the passivation layer 37 may be formed, and the pixel electrode 40 may be formed to be electrically connected to the drain electrode 29.

After the pixel electrode 40 is formed, a column spacer 240 for supporting a gap between the display substrate 200 and the opposite substrate 70 may be formed, as illustrated in FIG. 6G.

In FIGS. 6B through 6G, it is illustrated such that lines indicating a pattern or layers located below are visible in order to show the elements of the display substrate 200. However, lines indicating some patterns or layers may not be visible when seen from above.

Seven masks, for example, may be used to form the display substrate 200 of FIGS. 6A through 6G and a low power consumption may be realized by the gate wiring pattern 220 having the divided structure.

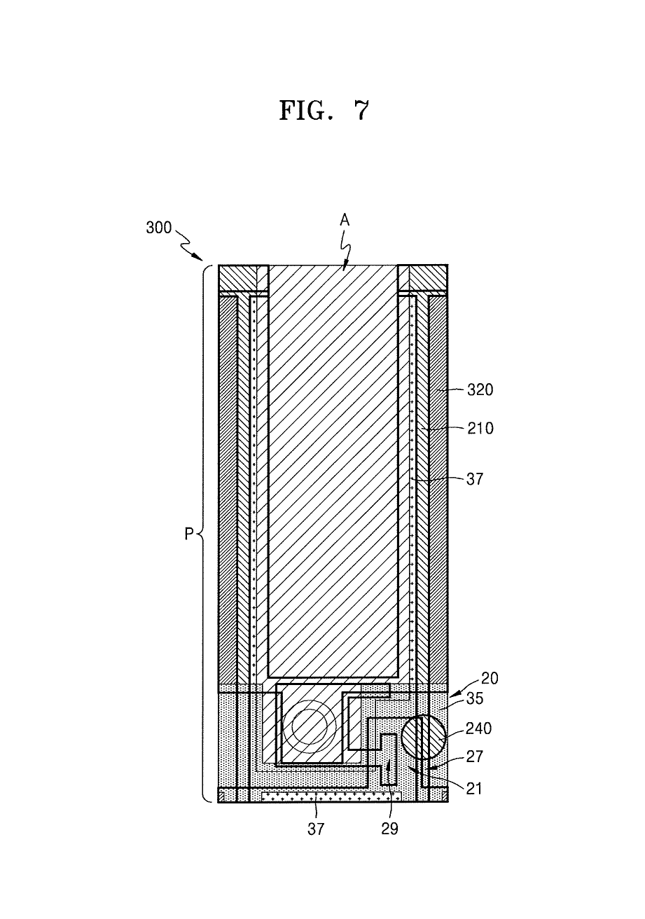

FIG. 7 is a plan view of a display substrate 300 which may be adopted as the display substrate 10 of the liquid crystal display 1 of FIG. 1, according to an exemplary embodiment of the inventive concept. FIG. 7 illustrates a unit pixel P of the display substrate 300. In the display substrate 300, the unit pixels P illustrated in FIG. 7 may be arranged in a two-dimensional array. The display substrate 300 of FIG. 7 differs from the display substrate 200 of FIG. 5 in that a gate wiring pattern 320 formed in parallel with the data line 210 has a single line structure instead of the divided structure of the display substrate 200 of FIG. 5.

When the gate wiring pattern 320 is formed as the single line structure that is not divided, when compared with the gate wiring pattern 220 having the two divided structures illustrated in FIG. 5, an area occupied by the gate wiring pattern 320 may become smaller than an area occupied by the gate wiring pattern 220. Thus, according to an exemplary embodiment of the incentive concept, an aperture ratio of the unit pixel P may be improved. This is because wiring may have a required minimum width and the area occupied by the gate wiring pattern 320 may be smaller than the area occupied by the gate wiring pattern 220 because the gate wiring pattern 320 is formed as the single line structure while the gate wiring pattern 220 is formed as the two line divided structure.

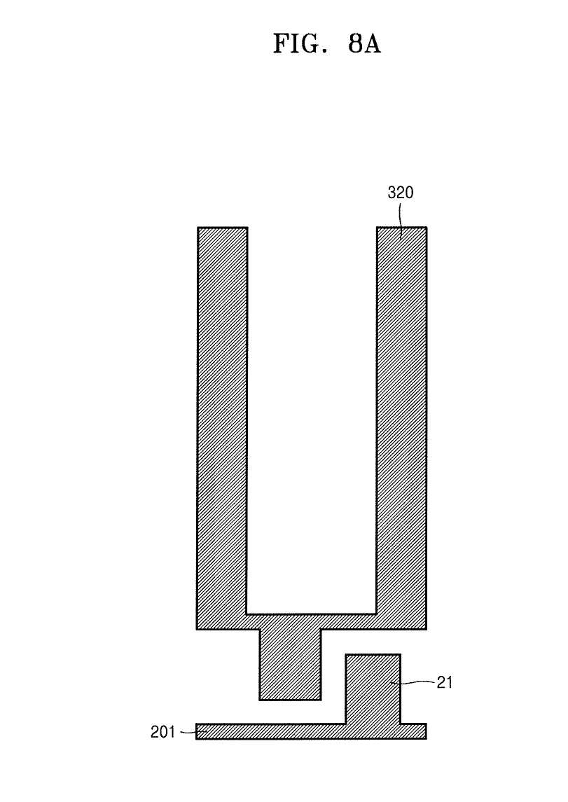

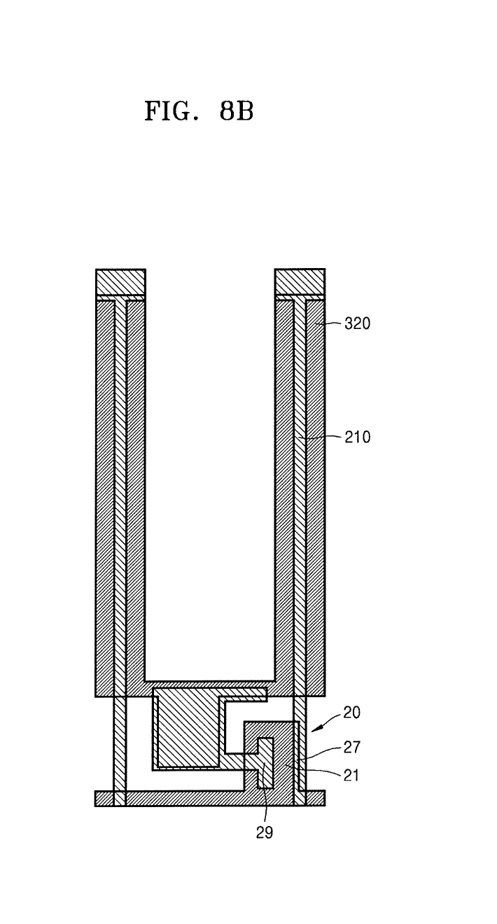

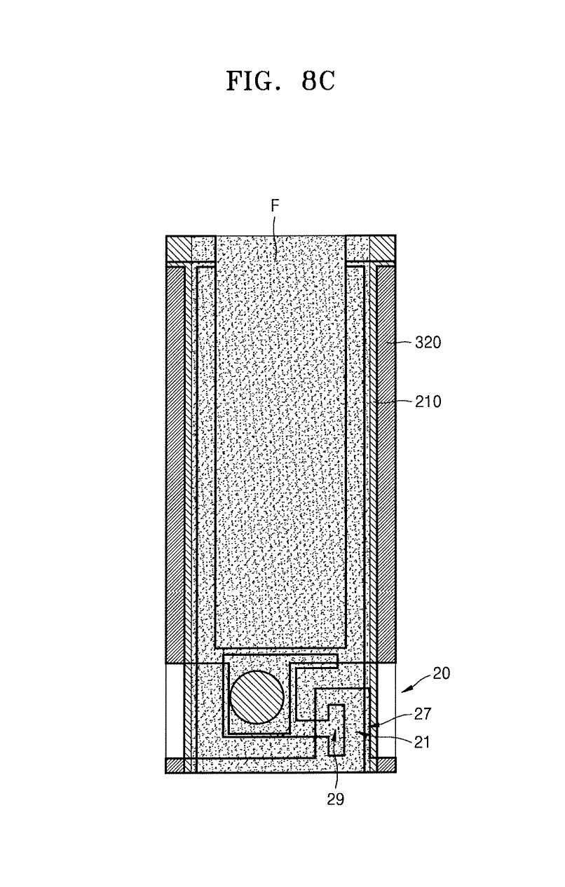

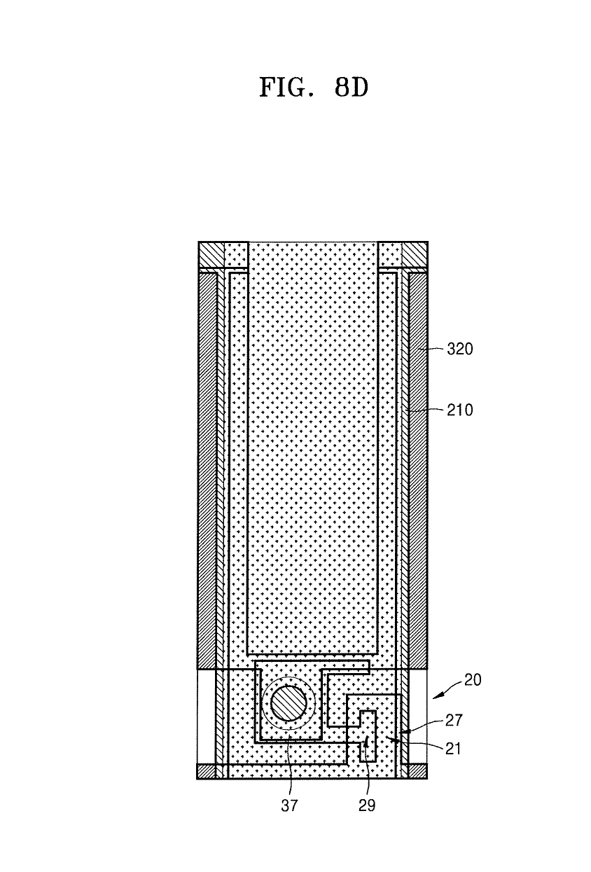

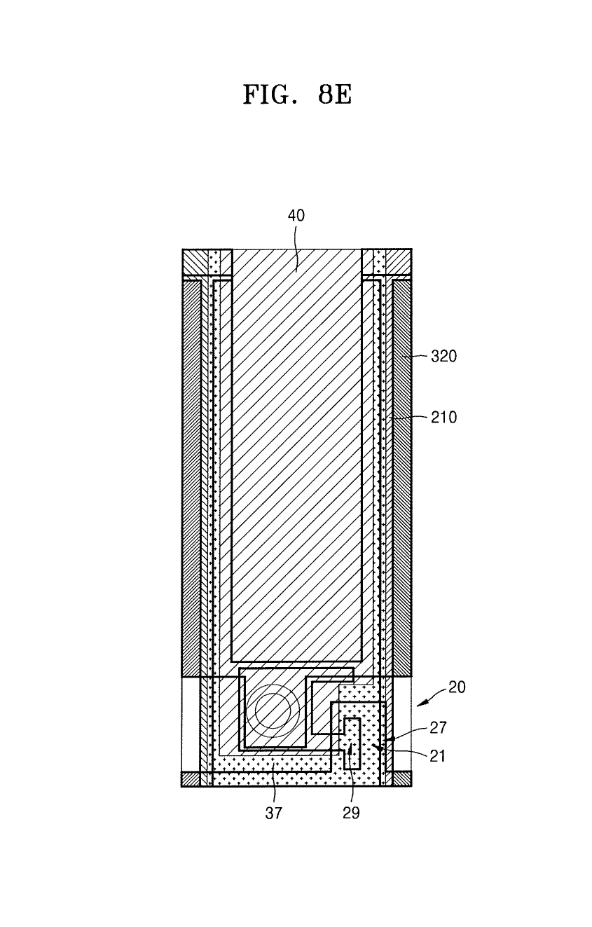

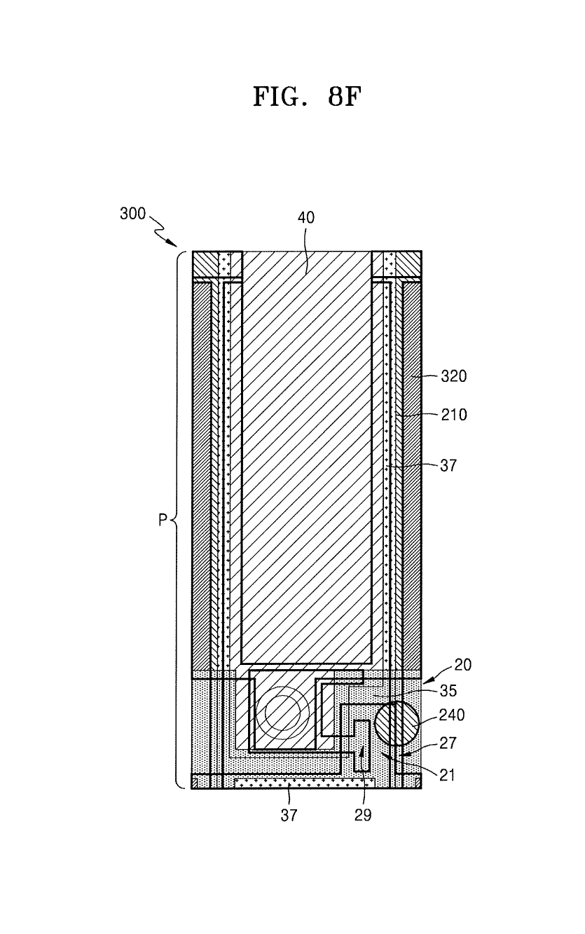

Also, compared with the gate wiring pattern 220 formed as the divided structure, light leakage between the gate wiring pattern 320 and the data line 210 may not occur when the gate wiring pattern 320 is formed as the single line structure. Thus, the black matrix 230 does not have to be formed in advance. In FIG. 7, the illustration of the black matrix 230 is omitted. Accordingly, the number of masks required may be reduced as shown in a method of manufacturing the display substrate 300 according to an exemplary embodiment of the inventive concept which is described with reference to FIGS. 8A through 8F.

FIGS. 8A through 8F are views illustrating the method of manufacturing the display substrate 300 of FIG. 7 according to an exemplary embodiment of the inventive concept.

Referring to FIG. 8A, a gate electrode 21 may be formed simultaneously with a gate line 201 and a gate wiring pattern 320. The gate wiring pattern 320 has a single line structure.

As illustrated in FIG. 8B, the gate insulating layer 23 and the active layer 25 may be formed to cover the gate electrode 21. In FIG. 8B, the gate insulating layer 23 and the active layer 25 are not illustrated for clarity of illustration. The source electrode 27 and the drain electrode 29 may be formed to be apart from each other. When the source electrode 27 and the drain electrode 29 are formed, the data line 210 may be formed to be electrically connected to the source electrode 27.

After the switching device 20 is formed as described above, an array of a red, green, and blue color filter F may be formed in unit pixel P as illustrated in FIG. 8C. FIG. 8C illustrates an example in which the color filter F of the unit pixel P is formed to cover not only the pixel area A, but also at least a portion of a width of the gate wiring pattern 320, a portion of a width of the data line 210 and a region of the switching device 20.

As illustrated in FIGS. 8D and 8E, the passivation layer 37 may be formed and the pixel electrode 40 may be formed to be electrically connected to the drain electrode 29.

After the pixel electrode 40 is formed, a column spacer 240 for supporting a gap between the display substrate 300 and the opposite substrate 70 may be formed, as illustrated in FIG. 8F. The opposite substrate 70 is not shown in FIG. 8F. When the column spacer 240 is formed, the light-shielding member 35 to cover and protect the switching device 20 may be formed and a black matrix may be formed on a required portion of the display substrate 300. Here, the light-shielding member 35 may be included in the black matrix.

Six masks, for example, may be used to form the display substrate 300 of FIGS. 8A through 8F and an aperture ratio may be further increased by the gate wiring pattern 320 having the single line structure.

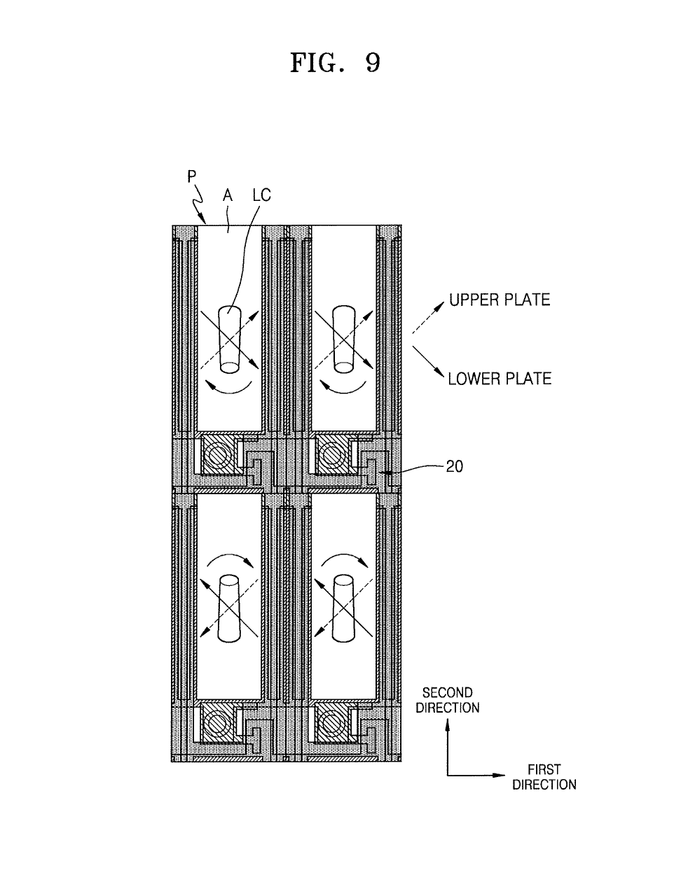

Meanwhile, the case in which the liquid crystal display 1 according to an exemplary embodiment of the inventive concept is provided such that a liquid crystal direction of a first unit pixel P is opposite to a liquid crystal alignment direction of a second unit pixel P adjacent to the first unit pixel P in at least one direction (e.g., left or right in a direction along the first axis, or up or down in a direction along the second axis). However, exemplary embodiments of the inventive concept are not limited thereto. According to an exemplary embodiment of the inventive concept, the liquid crystal display 1 may be provided such that a liquid crystal direction of a first unit pixel P is opposite to a liquid crystal alignment direction of a second unit pixel P adjacent to the first unit pixel P in only one direction (e.g., either left or right in a direction along the first axis, or up or down in a direction along the second axis). FIG. 9 illustrates an exemplary embodiment of the inventive concept in which the liquid crystal display 1 is provided such that a liquid crystal direction of a first unit pixel P is opposite to a liquid crystal alignment direction of a second unit pixel P adjacent to the first unit pixel P in the second direction (e.g., along the vertical axis), and in which a liquid crystal direction of a third unit pixel P adjacent to the first unit pixel P in the first direction (e.g., along the horizontal axis) is the same as the liquid crystal alignment direction of the first unit pixel P.

According to the liquid crystal display 1 configured to operate in the TN mode, the number of masks required in the process of manufacturing the liquid crystal display 1 may be reduced, and thus, the manufacturing costs may decrease. Also, since the liquid crystal alignment is formed within the gate line 201 and the data line 210, a loss in an aperture ratio due to disinclination may be prevented and the pixel area A may be formed as a single domain to have a high aperture ratio so that a high transmittance may be realized. For example, a liquid crystal direction of a first unit pixel P is opposite to a liquid crystal alignment direction of a second unit pixel P adjacent to the first unit pixel P in at least one direction (e.g., left or right in a direction along the first axis, or up or down in a direction along the second axis). Thus, optical compensation may be performed so that horizontal line color stains which may be generated in the case of the PLS mode are substantially prevented from occurring and viewing angles may be widened.

Therefore, electronic devices such as, for example, tablet products adopting the liquid crystal display 1 according to exemplary embodiments may have an improved aperture ratio, reduced power consumption, and enhanced display quality.

As described above, according to exemplary embodiments of the inventive concept, the liquid crystal display includes the alignment layer on an inner surface of the display substrate, wherein the alignment layer defines a pixel area formed as a single domain per unit pixel and a liquid crystal is aligned such that liquid crystal alignment directions of unit pixels adjacent in at least one direction are opposites with respect to each other. According to the liquid crystal display in accordance with an exemplary embodiment of the inventive concept, since the liquid crystal display may be configured to operate in the TN mode, the manufacturing costs may become low and the liquid crystal display may have a high aperture ratio and a high transmittance.

While exemplary embodiments of the inventive concept have been described with reference to the figures, it will be understood by those of ordinary skill in the art that various changes in form and detail may be made therein without departing from the spirit and scope of the inventive concept as defined by the following claims.

What is claimed is:

1. A liquid crystal display comprising:
a display substrate;
a plurality of unit pixels;
a switching device provided per unit pixel on the display substrate and configured to drive a corresponding unit pixel of the plurality of unit pixels; and
an alignment layer on an inner surface of the display substrate,
wherein the alignment layer defines a pixel area formed as a single domain per unit pixel, and
wherein a liquid crystal is aligned such that liquid crystal alignment directions of unit pixels adjacent in at least a first direction are opposite to each other.

2. The liquid crystal display of claim 1, further comprising a plurality of color display units,
wherein each of the color display units comprises a group of unit pixels from among the plurality of unit pixels configured to display a plurality of colors, and
wherein unit pixels of adjacent color display units which display a same color have opposite liquid crystal alignment directions.

3. The liquid crystal display of claim 2, wherein each of the color display units comprises three unit pixels arranged in one direction,
wherein the three unit pixels comprise a first unit pixel that displays a red color, a second unit pixel that displays a green color, and a third unit pixel that displays a blue color, and
wherein unit pixels that display the red color of two adjacent color display units have opposite liquid crystal alignment directions, unit pixels that display the green color of two adjacent color display units have opposite liquid crystal alignment directions, and unit pixels that display the blue color of two adjacent color display units have opposite liquid crystal alignment directions.

4. The liquid crystal display of claim 2, wherein unit pixels from among the plurality of unit pixels arranged in a second direction that crosses the first direction display the same color.

5. The liquid crystal display of claim 4, wherein adjacent unit pixels displaying the same color in the second direction have opposite liquid crystal alignment directions.

6. The liquid crystal display of claim 1, wherein the plurality of unit pixels are arranged in a two-dimensional array, and
wherein a liquid crystal direction of a first unit pixel from among the plurality of unit pixels is opposite to a liquid crystal alignment direction of a second unit pixel adjacent to the first unit pixel in at least one of the first direction and a second direction, wherein the second direction crosses the first direction.

7. The liquid crystal display of claim 1, further comprising a color filter on the display substrate.

8. The liquid crystal display of claim 1, wherein the alignment layer is a light-alignment layer.

9. The liquid crystal display of claim 1, wherein the liquid crystal display operates in a twisted nematic (TN) mode.

10. A method of manufacturing a liquid crystal display, the method comprising:
forming a light-reactive material layer on a display substrate including a plurality of unit pixels and a switching device per unit pixel;
irradiating the light-reactive material layer with light at a predetermined first incident angle through a shadow mask including a blocking area and a transmittance area, wherein the blocking area and the transmittance area each have a size corresponding to a size of each unit pixel, and wherein the blocking area and the transmittance area are alternately located in at least one of a first direction and a second direction crossing the first direction;
shifting the shadow mask by a distance corresponding to a width of the unit pixel; and
irradiating the light-reactive material layer with light through the shadow mask at a second incident angle, opposite to the first incident angle, on the light-reactive material layer to form a light alignment layer such that a pixel area per unit pixel forms a single domain and liquid crystal alignment directions of adjacent unit pixels are opposite to each other.

11. The method of claim 10, wherein the light comprises linearly polarized ultraviolet rays.

12. The method of claim 10, further comprising forming a plurality of color display units,
wherein each of the color display units comprises a group of unit pixels from among the plurality of unit pixels for displaying a plurality of colors, and
wherein unit pixels of adjacent color display units which display a same color have opposite liquid crystal alignment directions.

13. The method of claim 12, wherein forming each of the color display units comprises forming three unit pixels arranged in one direction,
wherein the three unit pixels comprise a first unit pixel that displays a red color, a second unit pixel that displays a green color, and a third unit pixel that displays a blue color, and
wherein unit pixels that display the red color of two adjacent color display units have opposite liquid crystal alignment directions, unit pixels that display the green color of two adjacent color display units have opposite liquid crystal alignment directions, and unit pixels that display the blue color of two adjacent color display units have opposite liquid crystal alignment directions.

14. The method of claim 12, wherein unit pixels from among the plurality of unit pixels arranged in a second direction that crosses the first direction display the same color.

15. The method of claim 14, wherein adjacent unit pixels displaying the same color in the second direction have opposite liquid crystal alignment directions.

16. The method of claim 10, wherein the plurality of unit pixels are arranged in a two-dimensional array, and
wherein a liquid crystal direction of a first unit pixel from among the plurality of unit pixels is opposite to a liquid crystal alignment direction of a second unit pixel adjacent to the first unit pixel in at least the first or the second direction.

17. A liquid crystal display comprising:
a display substrate;
a plurality of unit pixels;
a switching device provided per unit pixel on the display substrate and configured to drive a corresponding unit pixel of the plurality of unit pixels; and
an alignment layer on an inner surface of the display substrate,
wherein the alignment layer defines a pixel area formed as a single domain per unit pixel,
wherein the plurality of unit pixels comprises a first unit pixel adjacent to a second unit pixel in a first direction, and a third unit pixel adjacent to the second unit pixel in a second direction crossing the first direction, and
wherein at least the first unit pixel or the third unit pixel has a liquid crystal alignment direction opposite to a liquid crystal alignment direction of the second unit pixel.

18. The liquid crystal display of claim 17, further comprising a plurality of color display units,
wherein each of the color display units comprises a group of unit pixels from among the plurality of unit pixels configured to display a plurality of colors, and
wherein unit pixels of adjacent color display units which display a same color have opposite liquid crystal alignment directions.

19. The liquid crystal display of claim 18, wherein each of the color display units comprises three unit pixels arranged in one direction,
wherein the three unit pixels comprise a first unit pixel that displays a red color, a second unit pixel that displays a green color, and a third unit pixel that displays a blue color, and
wherein unit pixels that display the red color of two adjacent color display units have opposite liquid crystal alignment directions, unit pixels that display the green color of two adjacent color display units have opposite liquid crystal alignment directions, and unit pixels that display the blue color of two adjacent color display units have opposite liquid crystal alignment directions.

20. The liquid crystal display of claim 18, wherein unit pixels from among the plurality of unit pixels arranged in the second direction axis display the same color.
